(19) United States
(12) Patent Application Publication
(10) Pub. No.: US 2018/0216664 A1
(43) Pub. Date: Aug. 2, 2018

(54) System and method for functional validation of modular automatic control device for rotating apparatus

(71) Applicant: Simon Estomih Mushi, San Diego, CA (US)

(72) Inventor: Simon Estomih Mushi, San Diego, CA (US)

(21) Appl. No.: 15/883,103

(22) Filed: Jan. 30, 2018

Related U.S. Application Data
(60) Provisional application No. 62/451,773, filed on Jan. 30, 2017.

(51) Int. Cl. F16C 32/04; F04D 29/058; G05B 19/02

(52) U.S. Cl. CPC F16C 32/0455; G05B 19/02; F16C 32/0474; F04D 29/058

(57) ABSTRACT

Magnetic bearings are used to support high speed machinery, for example, pumps, compressors, motors and generators, and require active electronics and an automatic feedback control system to realize their function. This invention pertains to improvements of the design of automatic control systems for magnetic bearings to enable system performance validation without requiring all the external components of the rotating apparatus to be present.

### RELATED APPLICATIONS

The present application claims priority from U.S. Provisional Application No. 62/451,773, filed on Jan. 30, 2017, the disclosure of which is hereby incorporated by reference herein in its entirety.

### FIELD OF THE INVENTION

The present invention relates to design and practical realization of automatic control systems for magnetic bearing devices providing support for rotating apparatus and the like.

More particularly, the invention relates to an improved system architecture partitioning the devices that comprise the automatic control system in a manner supporting complete validation of the control system devices without requiring attachment to the any or all components of the rotating apparatus.

### BACKGROUND OF THE INVENTION

Magnetic bearings find application across many industries that employ high performance rotating machinery and in environments where conventional mechanical bearings are not suitable. Applications include but are not limited to high speed motors and generators, energy storage flywheels, gas compressors and pumps, and are well described in many publications such as B1.

A complex system of electronics or electronics plus software is needed to enable the function of a magnetic bearing. The heart of this system is a feedback control algorithm typically implemented on a discrete-time sampled-data digital control system. Information about constantly changing physical attributes of the rotating machine, such as rotor displacement in multiple degrees of freedom at multiple locations, and current, flux or voltage within the magnetic bearing coils are typical inputs to the algorithm. The force to be applied by the magnetic bearing to the rotating machine are the typical outputs. Electronic components of the automatic control system transduce the algorithm inputs and outputs in-order to realize the action of the magnetic bearing many thousand times per second.

Problems that arise during the system test and integration phase of prototype magnetic bearing systems are a source of costly delays during their development. The same issues can arise during first commissioning of the magnetic bearing system at a customer site. Common issues are, but not limited to, failure of the feedback control algorithms, failure of the electronic components of the magnetic bearing controller, failure of customer equipment interfacing with the magnetic bearing. Due to the complexity of the magnetic bearing systems, in particular the feedback control algorithm, it can be difficult to quickly pinpoint the root cause of failures. It is highly desirable to validate the control algorithm(s) and the electronic interfaces of the magnetic bearing system as thoroughly as possible during the design phase. Validation in this case means proving, qualitatively and also quantitatively, that the software algorithms and hardware electrical circuits work as intended in a variety of pre-determined use cases.

Computer simulations using discipline specific computer aided design/engineering (CAD/CAE) tools are used for design verification of the individual parts of a magnetic bearing system. However, they are unable to verify the fully integrated combination of feedback control algorithms, sampled-data digital control system and all electronic interfaces of a magnetic bearing system. Existing CAD/CAE tools are also unable to verify correct interaction of the magnetic bearing system with the customer's supervisory control and data acquisition system.

Though the general development of the individual components of an AMB system is understood, a major challenge is system integration at the customer, particularly for first of a kind systems. In such situations immensely skilled individuals are required to be on-site to ensure the AMB system can support the rotating machinery operation through a variety of use cases governed by the customer. When problems do arise it is difficult to quickly pinpoint precisely what may be wrong. Some questions that may be asked are: is it a design implementation problem, a component failure, an environmental disturbance, or an incorrect test case? What is needed is a means to diagnose design errors, in particular software errors, and perform as detailed as possible real-world system performance validation before shipment to the customer.

With the benefits of magnetic bearings well accepted in a wide range of industrial applications there is a push towards cost reduction of the magnetic bearing system components, for example, through the use of off the shelf conventional 3-phase motor drives which are already in mass production. This is described in a specific application by A3. Further, cost reductions are possible through the use of modular approach to the architecture of a magnetic bearing automatic control system to encourage heterogeneity, or inter-operability across different vendor components.

### BRIEF SUMMARY OF THE INVENTION

It is an object of this invention to define a modular control system architecture partitioning the electrical components and computation elements supporting the design and operation of magnetic bearing supported rotating machines in a heterogeneous manner.

It is a further object of this invention to define a system and method of using additional computation elements and electrical components to ascertain the real-world system performance of the magnetic bearing automatic control system, i.e., validate the functional behavior of the system while using the actual components and hardware and software interfaces of the modular magnetic bearing control system.

### BRIEF DESCRIPTION OF THE DRAWINGS

For a more complete understanding of the invention, reference is made to the following description and accompanying drawings, in which:

FIG. 1 is a diagram showing a shaft supported by five axis magnetic bearing system;

FIG. 2 is a functional block diagram depicting the high-level architecture and context of the modular magnetic bearing control system for a rotating apparatus;

FIG. 3 is a functional block diagram depicting high-level architecture of the functional validation system showing where it replaces the rotating apparatus and other equipment to interface with the computation module;

FIG. 4 is a block diagram which depicts the components comprising the computation module;

FIG. 5 is a block diagram which depicts the components comprising the simulation module;

FIG. 6 is a flow chart of the activities executed on the computation module; and

FIG. 7 is a flow chart of the simulation algorithm executed on the simulation module.

### DETAILED DESCRIPTION OF THE PREFERRED EMBODIMENTS

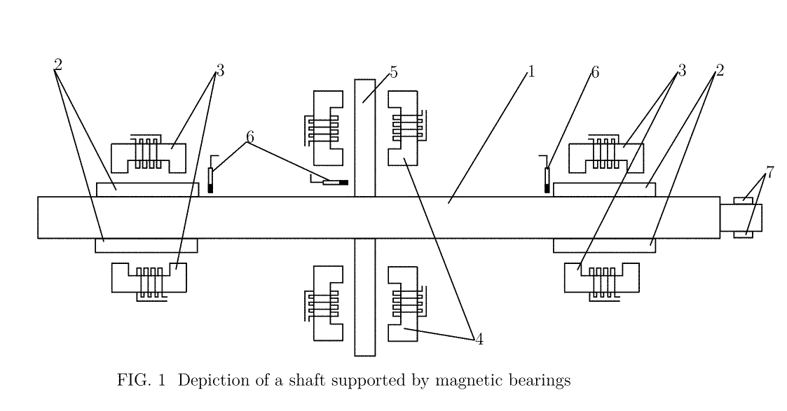

The arrangement in FIG. 1 shows an exemplary arrangement of a preferred embodiment of a shaft supported by a five axis magnetic bearing. The core electro-mechanical components of the rotating apparatus are the shaft [1], radial magnetic bearing rotors [2] and stators [3], and axial magnetic bearing rotor [5] and stator [4]. For a typical shaft with 5 axes of control, two radial magnetic bearings are used to provide support radial support for the shaft at two locations, and a single axial magnetic bearing provides support in the axial direction. Also shown are non-contact displacement sensors [6] that measure the shaft displacement at the magnetic bearing locations, and an angular position and velocity sensor [7] to measure the shaft rotation speed.

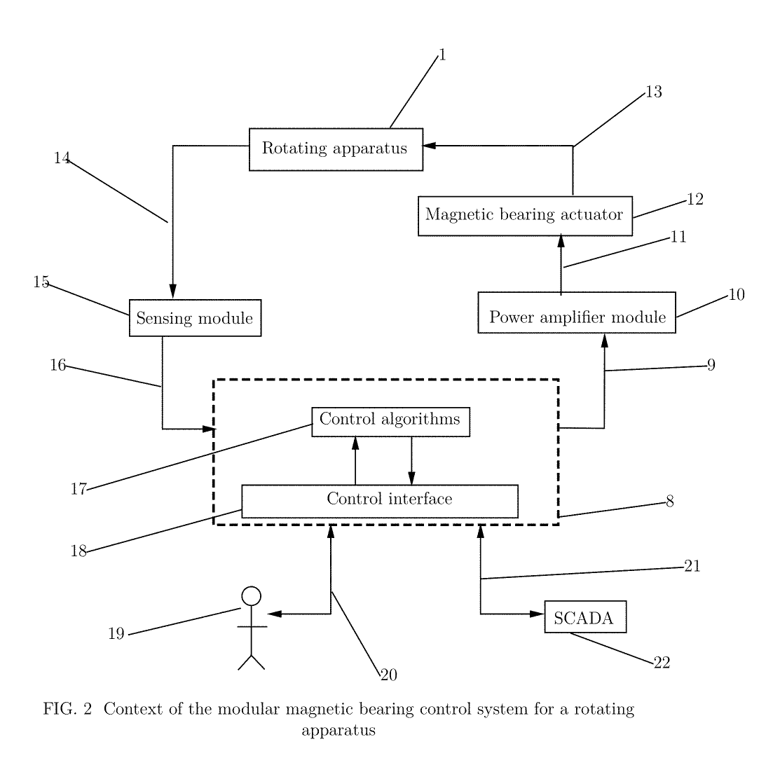

The arrangement in FIG. 2 shows an exemplary arrangement of a preferred embodiment. In FIG. 2, one sees the context in which the modular magnetic bearing control system exists. The five major parts of the system are the computation module [8], power amplifier module [10], sensing module [15], active magnetic bearing [12] and the shaft [1] being supported. As mentioned earlier, examples of the rotating apparatus include but are not limited to high performance rotating machines such as motors, generators, compressors, flywheels and pumps. The computation module [8] (henceforth abbreviated as CM) serves as the brains of a modular magnetic bearing automatic control system. The computation module represents a sampled-data discrete-time control system and may be implemented with a combination of one or more general purpose application central processing units (CPU) such as Intel Atom or ARM Cortex-A cores; micro-controller units (MCU) such as Freescale MPC56xx or Texas Instruments C2000 families; digital signal processors (DSP) such as Texas Instruments C6000 or Analog Devices Blackfin chip families; application specific integrated circuits (ASIC); field programmable gate array (FPGA) such as Xilinx Spartan-6 or the Intel Arria; or a system-on-chip (SoC) containing two or more of the aforementioned processing devices plus additional components in one package such as Texas Instruments OMAP-L138. The platform selected for the computation module may depend on several factors, including but not limited to, required computational performance, signal interfacing capabilities, ease of programming, reliability and cost.

The functions of the computation module may be split into two parts, control algorithms [17] required for the feedback control system to function, and control interface [18] to interact with the human user [19] or the factory control system [22]. The control algorithms [17] may be implemented on a real-time computation platform. A real-time computation platform is characterized by being able to generate an output in response to each and every input within a fixed time deadline and where the penalty for missing the deadline is severe. On the other hand, control interface [18] may be implemented on a non real-time computation platform. A non real-time computation platform is not designed or intended to meet stringent task deadlines, and so long as an update is delivered on the order of a second, is well suited for human interaction and network communication tasks.

In further detail, the control interface [18] may be implemented on a second core of a multi-core central processing unit (CPU), or as the only CPU in the embedded computer system. Such a CPU or core is named the host processor. The processor executing the control algorithms [17] is named the target processor. The host and target are connected by digital communication channel. Commonly used industry standard digital communication channels are PCI (peripheral component interconnect), SRIO (serial rapid input output), PCI-Express, PXI, Ethernet, to name but a few. The choice of communication channel protocols and electrical design affects the data bandwidth and latency of the communication channel and hence the overall performance and features of the modular magnetic bearing control system. Tasks performed by the host processor include, but are not limited to, preparing the modular magnetic bearing control system for use from the moment electrical power is initially applied; establishing communication between the host and target; loading firmware image to target; establishing communication between the computation module and the other equipment; transmitting settings or parameters to the target system; operating a graphical user interface [20] or GUI so that the end user [19] may interact with the modular magnetic bearing control system.

Typical end-users of magnetic bearing supported rotating machines have a desire to monitor and co-ordinate the operation of the magnetic bearing control system with other equipment in a facility from a central location. This monitoring and co-ordination function is performed by a supervisory control and data acquisition [22] or SCADA system. The computation module communicates with the SCADA via the SCADA and CM interface [21]. The SCADA and CM interface [21] may be implemented using a hardwired transistor output digital signaling (for example open collector or drain schemes), or standard industrial communication technologies such as CANbus or Modbus RTU or ModBus TCP. CANbus describes both physical layer and protocol layers, where as Modbus is independent of the physical layer which could be RS232/RS485 or Ethernet.

The control algorithms [17] will be addressed in more detail later in this disclosure. However, at a high level the sort of actions performed may include reading of analog and digital inputs, application of signal processing to analog inputs and digital inputs (for example anti-alias filtering and gain/offset correction for analog signals, and galvanic isolation, debouncing, implementation of counters/timers for the digital signals); execution of multiple algorithms to compute output current/force needed to support the rotating apparatus of the magnetic bearing system, perform diagnostics, prognostics and condition monitoring, write analog and/or digital outputs to the power amplifiers and other equipment in the modular magnetic bearing system. The core algorithm for the computation module is the servo feedback control algorithm that supports the shaft. Since magnetic bearing systems are open-loop unstable, a feedback controller is mandatory for stable operation. The feedback control law may be based on classical frequency-domain based laws such as proportional-integral-derivative (PID) and lead-lag operations, or modern time-domain designs rooted in robust, adaptive or non-linear system design approaches. Another type of algorithm employed along side the feedback controller in magnetic bearing systems are feed-forward control laws. Feed-forward control laws are used minimize the impact of synchronous disturbances (such as mechanical shaft imbalance, mechanical and electrical runout) on the operation of the magnetic bearing. Since the rotating speed of the apparatus is known, so is the frequency and phase of these repetitive disturbances. Hence, with some adaptation it is possible to minimize their effect on the system.

The power amplifier module [10] or PAM, converts the low voltage, low power command output from the computation module to a high voltage signal capable of driving the required current through the windings of the active magnetic bearing [12] in-order to generate force. The output command may be an analog reference voltage, or a digital signal encoded with pulse width modulation. Switch mode power amplifiers are almost universally used because of their higher efficiency. However, careful design is needed to keep the electromagnetic interference generated by the switching action as low as possible. A typical PAM for a rotating apparatus with 2 radial and 1 thrust bearing contains either 5 or 10 amplifiers depending on how the constant bias for the magnetic bearings is generated, i.e. using electromagnets or permanent magnets. The signals exchanged between the PAM and CM are transmitted over the computation module and power amplifier module interface [9]. In addition the command output from the CM, the computation module and power amplifier module interface [9] transmits amplifier status information back to the CM. Amplifier status may include, but is not limited to, fault status, output enable status, supply voltage input status. The power amplifier and active magnetic bearing interface [11] is the electrical link between the PAM and the windings that make up the magnetic bearing actuator. The link may be a few cm to hundreds of meters in length, and thus its design must take into account electrical losses and electromagnetic interference. Not shown in FIG. 2 is the high voltage direct-current power supply that may be required for the power amplifiers to operate.

There are numerous sensors located throughout the modular magnetic bearing control system. Examples include, but are limited to, accelerometers for machine foundation monitoring, shaft angular velocity and angular displacement sensors (i.e. rotary encoders or resolvers), shaft radial and axial displacement sensors, magnetic bearing stator temperature sensors, electrical current sensors for the magnetic bearing windings, magnetic flux sensors for the magnetic bearing actuator. While the sensors are practically spread out in different physical locations, the purpose of the sensing module [15] or SEM is to logically organize the function that all sensors provide into a single block. For example the winding current sensors may be located in the power amplifier module [10], while the shaft radial displacement sensors are located in the vicinity of the rotating apparatus [1]. Sensor signal processing functions including, but not limit to, demodulation of the carrier frequency and temperature compensation in the displacement sensors, ratio-metric measurement for RTDs, and shaft resolver to digital conversion are performed in the SEM. The SEM block has an interface with the computation module [16] that provides electrical power to the sensors, and transmits the transducer outputs to the computation module via analog or digital signaling. The SEM also has an interface with the electromechanical hardware of the magnetic bearing system [14]. This physical interface includes sensors located in the power amplifier module [10] and on the shaft [1].

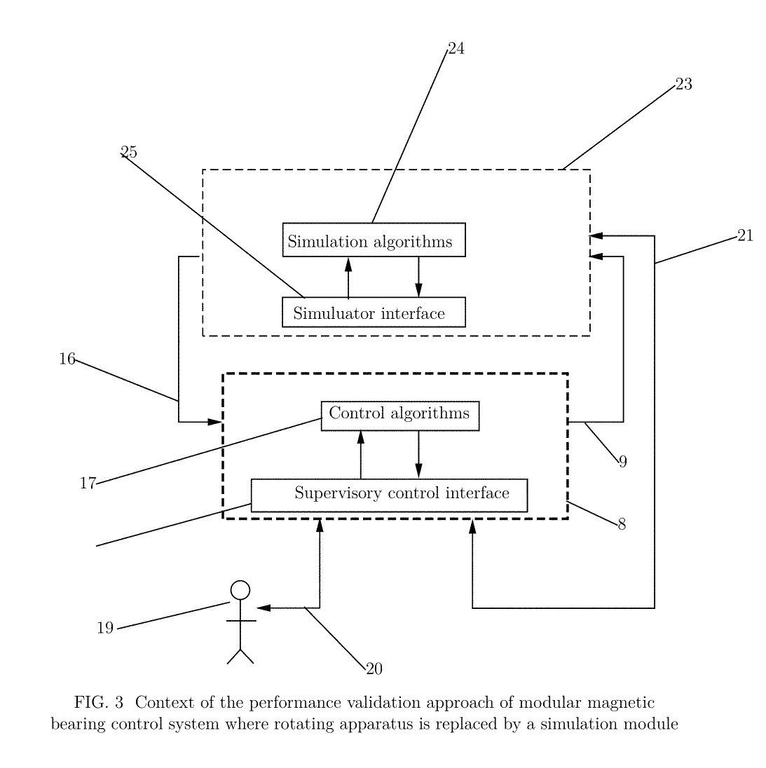

The arrangement in FIG. 3 shows the computation module [8] connected “back-to-back” with the simulation module [23] to enable the functional validation of the magnetic bearing control system as implemented on the computation module. This serves as an exemplary arrangement of a preferred embodiment of the performance validation approach that is the focus of this patent application. The simulation module [23] replaces numerous electromechanical components of the total system depicted in FIG. 2, specifically, the power amplifier module [10], active magnetic bearing [12], shaft [1], sensing module [15] and the interfaces between them. In addition, the simulation module emulates the supervisory control and data acquisition [22] element of the customer's control system. The electromechanical behavior of the components replaced by the simulation module are captured in the form of electronic circuits and simulation algorithms [24] executed on the simulation module. The simulator interface [25] provides a way for the user to select predefined system characteristics, for example, shaft rotation speed, shaft imbalance distribution, and other mechanical or electrical disturbances and then observe the response of the computation module.

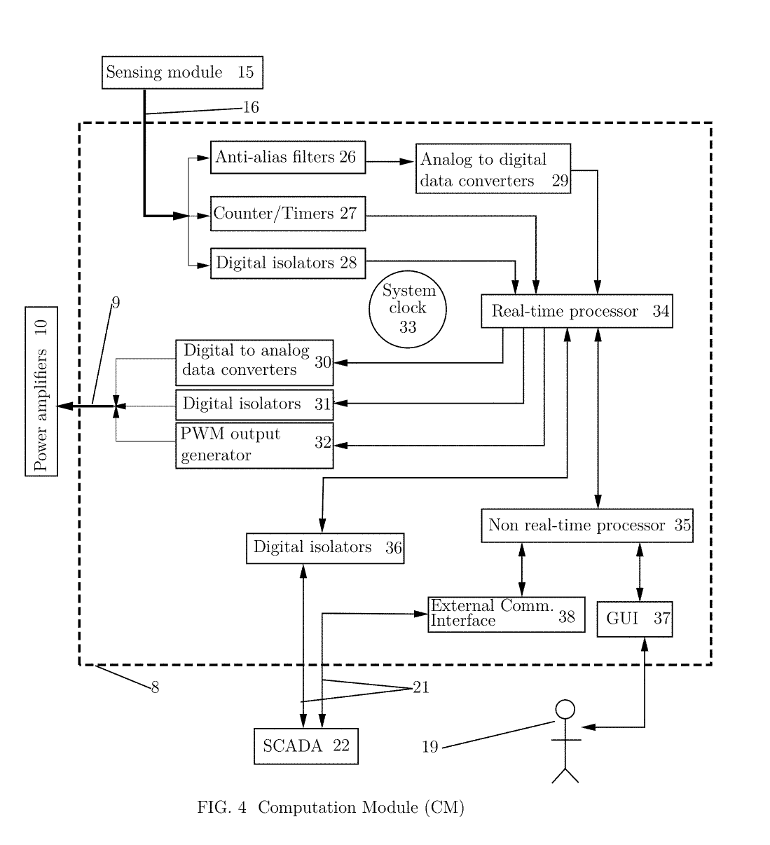

The arrangement in FIG. 4 shows an exemplary arrangement of a preferred embodiment of the computation module [8]. The heartbeat of the computation module is the computation module real-time clock [33] that serves to synchronize activities within the computation module. The frequency of this clock is selected based upon the fastest dynamics (electrical or mechanical) in the combined shaft-magnetic bearing system to be controlled. In general, the update rate of the algorithms running on the computation module should be 5 to 10 times faster than the dynamics of the system being controlled. A typical embodiment of the real-time component of the computation module is a digital signal processor, micro-controller or field programmable gate array. In such an embodiment, the computation module real-time clock [33] generates timing signals that control the operation of the sampled data converters (both digital to analog [29] and analog to digital [30]). Incoming analog signals such as shaft displacement, component temperature, magnetic bearing stator current or flux are processed with analog anti-alias filters [26] prior to being sampled by the computation module analog to digital data converter [29] and then transmitted to the computation module real-time processor [34]. Once the processor executes control algorithms, the resulting outbound analog signals such as amplifier command to analog amplifiers in the power amplifier module power amplifier module [10]. If digital amplifiers are used in the power amplifier module [10], then the amplifier command may be digitally encoded with pulse width modulation using the computation module pulse width modulation output [32] generator. Decoding of the shaft rotary encoder pulses allows real-time processor to determine the instantaneous rotor speed and angle. The computation module real-time clock [33] generates interrupts that allow the computation module real-time processor [34] to execute multiple tasks to support the operation of the digital control system. This clock also provides input to various computation module counter/timer inputs [27] that are used to measure the period of external events, for example rotary encoder pulses. The computation module real-time clock [33] also provides synchronized input to computation module pulse width modulation output [32] generator that may be used to command the amplifiers of the power amplifier module [10]. The computation module digital output interface [31] consists of circuitry to provide galvanic isolation of the digital outputs from the computation module destined for other components of the modular magnetic bearing control system, such as the power amplifier module [10]. The computation module SCADA-digital interface [36] provides galvanic isolation and voltage level-shifting for the computation module to send/receive low-level to/from the SCADA system [22]. The computation module non real-time processor [35] is responsible for supervising the operation of the computation module [8], by initializing the computation module real-time processor [34] with parameters at startup, providing an interface [37] for users [19] to directly interact with the computation module, and also supporting high-level external communication channels based on CAN bus or Modbus to the SCADA system via the computation module external communication interface [38]. In typical embodiments of the computation module, it is preferred to integrate as many of the components in FIG. 4 as is practically possible into the same integrated circuit package. This miniaturization allows for reduced unit costs and increased reliability. Typically custom interface components such as analog anti-alias filters [26] and bi-directional galvanic isolators [36] are placed off-chip to provide for customization to the end application.

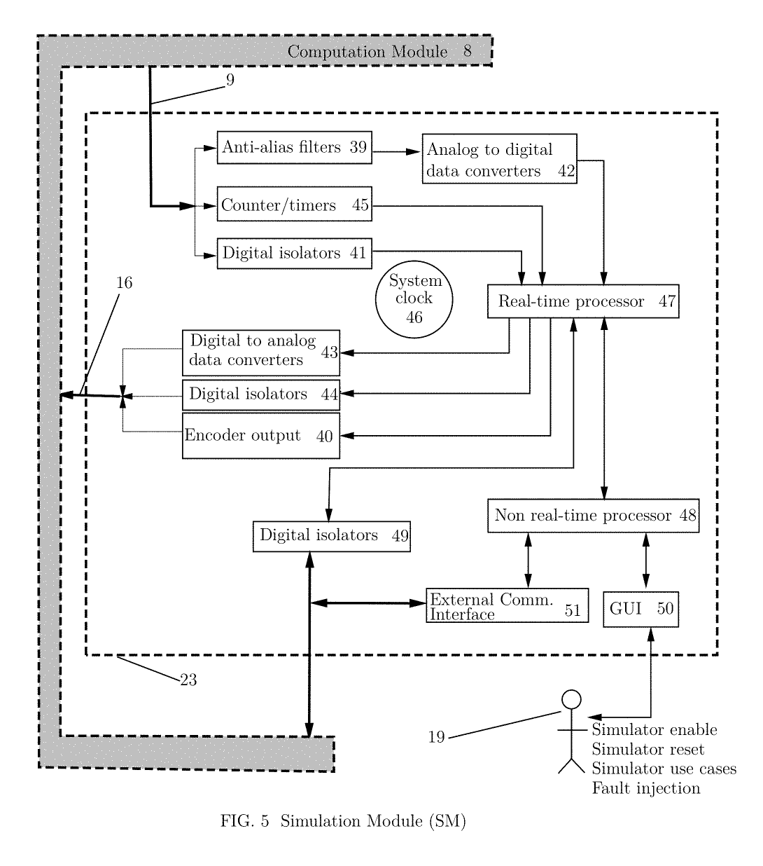

The arrangement in FIG. 5 graphically depicts the central role of the simulation module—to mimic as many components external to the computation module so as to enable the functional validation of the computation module. The simulation module is able to replicate the critical behaviors of the SCADA system [22], power amplifier module [10], magnetic bearing actuators [12], rotating apparatus [1], and sensing module [15]. The simulation module shares numerous hardware and software design elements with the computation module. The aforementioned approach to maintain design modularity reduces development time and final cost of goods through reuse of design elements and economies of scale, respectively. However, there are a few differences as explained below. The simulation module real-time clock [46] performs a similar role as the computation module real-time clock [33]. However, the simulation module [23] operates at a frequency 5 or 10 times faster than the update rate of the computation module so as to minimize the phase lag due to sampling on the approximated dynamic model. The algorithms representing dynamic models of the aforementioned magnetic bearing system components being simulated are executed in software on the simulation module real-time processor [47]. Some signal processing may be executed in hardware with either discrete analog or digital components, for example, to offload the computation burden of simulating the response of multiple power amplifier channels in software, a series of active low pass filters with digital potentiometers is preferred. As with the computation module, the real-time processor may be implemented with a digital signal processor, micro-controller or field-programmable gate array. The inputs for the simulation algorithms are the outputs of the computation module, i.e., analog or digital commands to the power amplifier module [10]. These signals are routed to the simulation module [23] via the computation module and power amplifier module interface [9]. The analog amplifier commands signals are processed with anti-alias filters [39] prior to being sampled by the analog-to-digital data converters [42]. If digital power amplifiers are employed, then the pulse width modulation encoded commands are input to counter/timers [45] to extract duty cycle and transistor firing pattern. With a model of the amplifier configuration and magnetic bearing electrical load characteristics, the duty cycle and transistor switch pattern can be used by the real-time processor to determine the electrical current produced in a magnetic bearing winding. Other digital outputs from the computation module are fed through galvanic isolators [41] prior to being transmitted to the real-time processor. As the outputs from the simulation module are a subset of the critical inputs to the computation module, for example, shaft displacement, shaft angular velocity and phase, power amplifier enable and power amplifier fault status they are fed back to the computation module via the computation module and sensing module interface [16]. The simulation module digital output interface [44] is used to output status information for the power amplifiers and power supplies to the computation module. The simulation module digital to analog data converter [43] and analog output interface return shaft displacement and other analog outputs such as magnetic bearing stator winding current, and component temperature to the computation module. The shaft angular velocity and phase outputs are handled by special circuitry in the encoder output module [40], capable of generating fast digital pulses to simulate an incremental rotary encoder. Dedicated electrical circuitry (either integrated on a DSP, or custom logic on an FPGA) is needed due to the high frequencies involved, for example, simulating a rotary encoder with resolution of 1024 count per mechanical cycle attached to a 12,000 rpm shaft shall require pulses less than 0.5 microseconds long and less than 5 microseconds apart. Such resolutions are a challenge to realize purely in software running on the simulation module real-time processor. As with the computation module, the simulation module non real-time processor [48] serves to co-ordinate all the high-level actions of the simulation module, particularly at startup. The non real-time processor hosts a graphical user interface [50] that allows users [19] to operate the simulation module, as well as the simulation module external communication interface [51] that mimics a SCADA system that the computation module expects to serve via the SCADA and CM interface [21]. Simulated low level digital I/O exchanged via this same interface is processed (for example, digital isolation and voltage level shifting) on the simulation module SCADA-digital interface [49] prior to reaching the real-time processor.

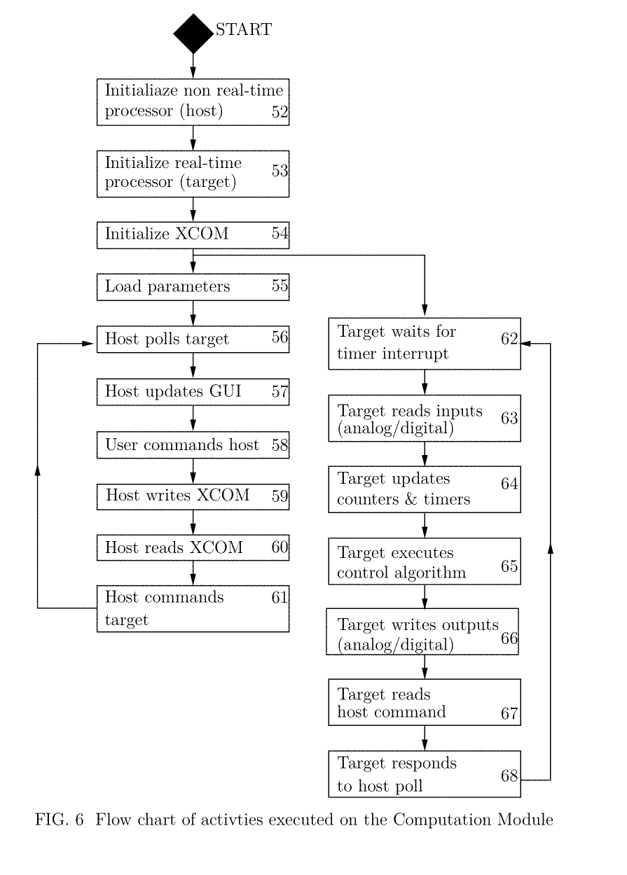

The arrangement in FIG. 6 shows a flow chart of activities executed on the computation module. When electrical power is first applied to the computation module, the first action executed by the computation module is to initialize the non real-time processor [52] or host. As referenced in FIG. 4, the host is responsible for readying the computation module real-time processor [34] for use, interfacing the magnetic bearing automatic control system with the human user [19] as well as with the SCADA system [22] responsible for the site operations. This initialization step includes loading of an operating system, loading of any device drivers required, and starting any required service programs. Once the computation module non real-time processor [35] is ready, the subsequent action is to initialize the real-time processor [53] or target. The initialization of the target involves the host uploading a firmware image to the target that contains the instructions and data for the target to begin running.

The subsequent action for the host is to initialize the external communications interface [54] abbreviated as XCOM. This interface to the system providing supervisory control and data acquisition [22] external to the magnetic bearing controller may be based upon communication standards or protocols such as CANbus and Modbus in addition to or rely upon low level digital interfaces such an open collector/drain transistor output schemes. Transistor output schemes are preferred for safety critical functions such as emergency off (EMO) and fault notification. It is desirable for low level status (for example system ON, system FAULT) and commands (for example TURN ON, EMERGENCY OFF, FAULT RESET) to be transmitted from the SCADA system to the target directly via low level digital interfacing which avoids software interfaces that may be less robust.

Even though the target may be running, it is not fully operational until the host provides the target with numeric values for parameters of the arithmetic and logic operations implemented to realize the control algorithms. These parameters, which may vary from one system to another, include but are not limited to control gains for the algorithm, gain/offset calibration values for any actuators or transducers. The load parameters [55] action provides this information to the target. Following this step, the activities on the target and host are now asynchronous and this is shown by a fork in the flow chart. The actions on the left are performed on the host, whilst the actions on the right are performed on the target.

The next six actions executed on the host repeat indefinitely with a period on the order of 1 second or less. The periodicity of the polling actions is such that data and commands may be exchanged between the host and target, and also between the host and the SCADA system via the XCOM interface. The first action is for the host to poll the target [56]. The target is alerted to this request with an interrupt. The host and target have a common memory space to allow for exchange of data. In response to the host, the target will populate the requested memory space with data so that in the next step the host is able to update the GUI [57]. The types of information shown on the GUI include and is not limited to, shaft displacement data, shaft speed, power amplifier current data, amplifier operational status, component temperature data, and various digital inputs/outputs. Since the GUI is intended for human use, often the next step after the host GUI update is for the user to use the GUI to issue commands to the host [58] or modify one or more calibration or operational parameters. The next action is for the host to write to the external communication interface [59] any status information retrieved from the target in a preceding step. The host subsequently reads back from the external communication interface [60] to determine what response to supply via the external communication interface on the next cycle. The final action in the repeating loop is for the host to send commands to the target [61] based on user input or an incoming request via the external communication interface.

Separately from the host loop, the following eight actions are executed on the target indefinitely with a period on the order of one hundred microseconds or less. The timing is tightly controlled by the system clock [33], which enforces deadlines for tasks on the real-time processor to be executed within. The timing is ensured through the use of interrupts. To ensure synchronization of reading sensor data and delivering an actuator response, the first step in the loop is to wait for the arrival of the interrupt [62] to generate an output. Once the servo interrupt is received, the first task is to read the analog and digital signals [63] inbound to the magnetic bearing controller. Analog input signals may include but are not limited to shaft displacement, component temperature, magnetic bearing winding current, magnetic bearing gap flux, et cetera. The analog signals are digitized by a sampled digital to analog converter and made available for processing. Digital input signals may include but are not limited to power amplifier module status, low level commands from the safety programmable logic controller (PLC) responsible for the rotating machinery apparatus, shaft mounted encoders or resolvers, key switches, emergency stop switches, et cetera. Some high speed digital signals, for example, shaft rotary encoder or resolver output, are typically fed into counter/timer circuits [64] that decode the data into frequency and or phase information which is made available for further processing by the control algorithm. The task that follows the collection of input data is the execution of the control algorithm [65]. This task may in practice be split into more than one discrete, synchronized sub-tasks who purpose is to perform real-time arithmetic and logic operations on the incoming data to generate output signals that will support the function of the magnetic bearing. The control algorithm may also be responsible for computing key performance indicators (KPIs) of the control system, and applying thresholds to these KPIs to determine where performance is or is not according to specification, and if necessary acting upon or alerting the host to act upon this information. Once all computations are completed, the subsequent task is for the target to update the analog and digital outputs [66]. Analog outputs may include but are not limited to command reference for analog based amplifiers in the power amplifier module. Digital outputs may include but are not limited to enable signals to relays controlling power supplies and amplifiers in the power amplifier module, pulse width modulated command reference for digital power amplifiers in the power amplifier module. The next task is for the target to read the command(s) [67] received when the host polled it [56]. This read action by the target is typically triggered by an interrupt sent by the host. The final step in the sequence is for the target to respond with status or other requested data to the host [68]. After this step completes, the target returns to wait for the next servo interrupt [62] to being processing inputs once more.

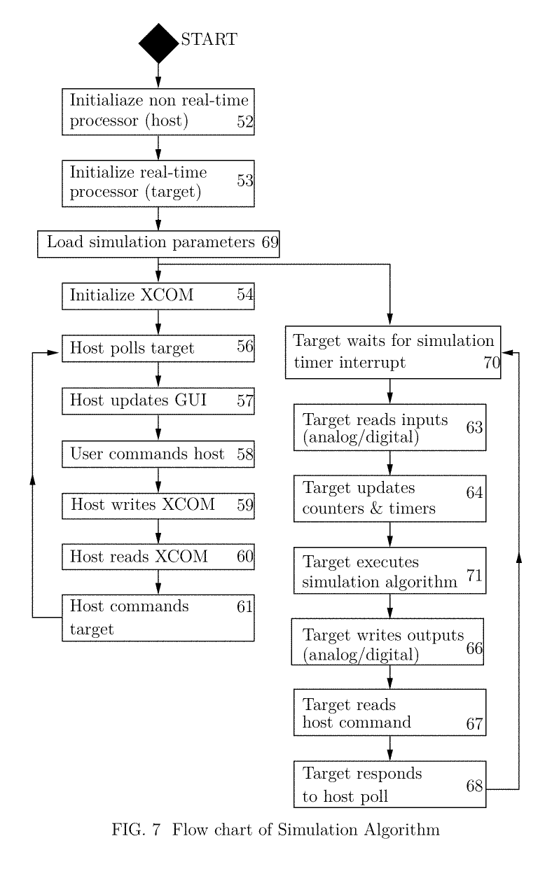

The arrangement in FIG. 7 shows a flow chart of activities executed on the simulation module. The flow chart for the simulation module has significant similarity with the control module. This conscious design choice is keeping with the paradigm of modularity emphasing re-use of design aspects. The key differences between FIG. 7 and FIG. 6 are in the parameter set used for operation, the specific arithmetic and logic operations implemented in the control versus simulation algorithms, the update rate of the simulation algorithm and additional hardware signal processing (utilizing analog or digital electronic circuits) performed to complete the simulation. The purpose of the simulation module is to capture the relevant electromechanical behavior of the magnetic bearing supported rotating apparatus, which requires a different set of parameters to be loaded [69] following the initialization of the processors. Parameters may include but are not limited to the descriptions of the shaft dynamics, electrical properties of the magnetic bearing itself, electrical properties of the amplifiers and other transducers (e.g. coil current, or shaft rotation rate) employed in the signal chain. For the hardware-in-the-loop simulation to successfully mimic the response of the real hardware, it must have an update frequency several multiples higher than the control algorithm. Therefore the servo interrupt utilized for the simulation module [70] is typically approximately 5 to 10 times faster than the control module. For example, a 8 kHz sample rate on the control module may require a greater than 40 kHz sample rate for the simulation module. The simulation algorithm executed on the target [71] implements the arithmetic and logic operations to capture the relevant electromechanical behavior of the magnetic bearing supported rotating apparatus.

For analog power amplifiers, an analog amplifier-winding model converts the amplifier command reference voltage [9] to the equivalent electrical current realized in the coil windings of the magnetic bearing. The parameters of the amplifier model include but are not limited to features of the magnetic bearing electrical construction e.g., electrical inductance and resistance, and features of the power amplifier construction, e.g., maximum voltage, maximum current, small signal bandwidth. For speed of execution the amplifier-winding dynamics can be represented with a first order model for each of the 5 control axes in the magnetic bearing system:

i=Gₐₘₚ(s)v, (1)

where Gₐₘₚ(s) is a continuous time transfer function from command voltage input v to resulting coil current i. As mentioned earlier, to offload the task of executing the amplifier model from the simulation module, Gₐₘₚ(s) may be implemented in electronic hardware instead of software. This hardware would be multiple 1^{st}, 2^{nd} or 3^{rd} order active low pass filters that incorporate digital potentiometers to vary the circuit response to match the amplifier-winding dynamics.

If digital power amplifiers are used in the system, a different electronic hardware circuit from what is described above is employed to convert the pulse-width modulated amplifier command reference voltage to the equivalent electrical current realized in the coil windings of the magnetic bearing. The duty-cycle can be directly extracted for the 5 or 10 amplifiers in the system through the use of counter/timers to measure the duration of a high level and the period of the signal. This duty-cycle is directly proportional to the equivalent electrical current. This equivalent electrical current may then be passed through a similar low pass filter to that described in the previous paragraph to capture additional dynamics of the amplifier.

The rotor dynamics model may be specified in a general manner:

Mᵣ\ddot{q}+ΩGᵣ\dot{q}+Kᵣq=BₑₓₜFₑₓₜ+B_{mag}F_{mag}

yₛ=Cₛq

y_{mag}=C_{mag}q, (2)

where q is a displacement vector of points along the rotor, Mᵣ is a mass matrix, Gᵣ is gyroscopic matrix, Kᵣ is internal stiffness matrix, Bₑₓₜ specifies which locations in q space the external forces Fₑₓₜ will act, and similarly B_{mag} specifies which location in q space the magnetic bearing force F_{mag} is applied, Ω is rotor angular velocity, yₛ is the rotor displacement at certain points of interest as defined by a coefficient distribution matrix Cₛ, y_{mag} is the rotor displacement at the magnetic bearing locations as defined by a coefficient distribution matrix C_{mag}.

The force exerted on the rotor by the magnetic bearing model is represented by:

F_{mag}=Kᵢi−Kₓy_{mag}, (3)

where Kᵢ is the current gain parameter of the magnetic bearing, i is the current in the multiple magnetic bearing coil windings, Kₓ is the negative stiffness parameter of the magnetic bearing. These two parameters are obtained by linearizing the force delivered by the magnetic bearing by considering the following: an opposing pair of bearings producing motion in a single degree of freedom; a bias current; and limiting the rotor displacement to small motions about the nominal center of the bearing clearance as explained in B1.

In addition to F_{mag}, there are external forces Fₑₓₜ acting on the system that must be considered during operation. These include the weight of the rotor F_{w} which may be considered to act at the center of gravity, forces due to fluid-structure interaction F_{fluid} for example cross-coupled stiffness induced loads at seals, F_{unb} force generated due to residual rotor unbalance and F_{UMP} the unbalanced magnetic pull, if any, generated by the stator of an electric motor assembly directly attached to the rotor:

Fₑₓₜ=F_{fluid}+F_{w}F_{unb}F_{UMP}. (4)

Through mathematical operations to collect like terms, equations 1 through 4 may be combined into a single continuous time state-space model of the form

\dot{x}(t)=Ax(t)Bu(t)

z(t)=Cx(t)+Du(t), (5)

where A, B, C and D are matrices, t is the time operator, u is the input vector, z is the output vector. The order of the model may be optimized through truncation of higher order dynamic features beyond the control bandwidth of the magnetic bearing using modal truncation or singular value based methods. The resulting low-order model is then converted to discrete-time form using the bilinear (Tustin) methodology. The selection of the bilinear or any other continuous-discrete time conversion methods is based on a consideration of the underlying model dynamics. To improve numerical conditioning the discrete-time state space model in modal canonical form is then balanced based on diagonal similarity transformation, resulting in an optimized discrete time model

xₖ₊₁=A_{d}x(k)+B_{d}u(k)

z(k)=C_{d}x(k)+D_{d}u(k), (6)

where A_{d}, B_{d}, C_{d} and D_{d} are matrices and k is the index for the discrete time series. The purpose of the aforementioned steps is to increase the sparseness of the matrices, i.e. have more zeros because then a multiply-accumulate (MAC) step may be eliminated. The final step in preparation of the model is a conversion to the numeric format of the target real-time processor to further enhance the execution time on the target processor. Examples of optimal numeric formats include single precision floating point for the TMS320C6713 DSP from Texas Instruments, or fixed point for the TMS320C6455 DSP from Texas Instruments. Prior to executing the optimized dynamic model on the simulation module, the optimized model is validated against the un-optimized version to ensure their results are in full agreement. An optimized matrix-vector computation algorithm that utilizes the sparseness of the above matrices to reduce the number of MAC operations required per sampling interval allows for a 20^{th} order simulation model with 5 inputs and 5 outputs, representing a typical 5 axis magnetic bearing system, to be executed within 16 microseconds on a Texas Instruments C6713 DSP, therefore enabling greater than 40 kHz sample rate of the simulation module.

The arrangement of electronic components in FIG. 4 and FIG. 5 and their external interfaces define the architecture to supporting functional validation of the automatic control system. The reason for this is that key interfaces shown in FIG. 2 between the computation module [8] and both the power amplifier module [10] and the sensing module [15] are independent of the realization of the computation module and accessible so that the simulation module [23] can fully replace them in order to emulate the operation of the full magnetic bearing system. The term independent of the realization may be taken to mean that a modular approach to the construction of the automatic control system hardware has been adhered to. This approach can take the form of building separate printed circuit boards for the modules, or building separate enclosures for the modules. In both cases, it is possible to interface the simulation module [23] to the computation module [8] by disconnecting cable connectors from the sensing module [15], power amplifier module [10] and supervisory control and data acquisition [22] or SCADA system and connecting the cables connectors to the simulation module [23] without the control module being able to distinguish the difference. This is because the interface at the signal and information levels has been perfectly duplicated on the simulation module [23].

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there-between.

What is claimed:

1. An apparatus and method for complete functional validation of a magnetic bearing automatic controller comprising algorithms running on a real-time digital processor, data converters, analog signal processing, digital interfaces, and a non real-time digital processor all connected to the device under test in such a way that salient behavior of all external components and interfaces can be subsumed into the proposed apparatus, herein referred to as the simulation module.

2. The proposed apparatus of claim 1 further comprising real-time processing elements based on either a digital signal processor, a field programmable gate array or a micro-controller, including additional analog or digital electronic circuits to offload signal processing tasks from the processor.

3. The proposed method of claim 1 further comprising algorithms realized in hardware and software on the apparatus to reproduce the electromechanical behaviors of the rotating apparatus external to the magnetic bearing automatic controller such as rotordynamics of the rotating shaft, and electrodynamics of the magnetic bearing actuator and power amplifiers, and the means to inject disturbances such as shaft imbalance, electromagnetic interference and component failure.

4. The proposed method of claim 1 further comprising a method for arranging electronic components of an automatic control system for a magnetic bearing supported rotating apparatus for the purpose of heterogeneous composition and functional validation.

5. The system of claim 4, wherein: the communications interface between computation elements of the automatic control system (collectively referred to as the computation module) and both the power amplifiers and sensors (including but not limited to rotor shaft position, angular velocity, magnetic bearing current and flux) is accessible so that the power amplifiers and sensor may be mimicked by a second automatic control system (simulation module);

6. The system of claim 3, further comprising: a means to emulate electrical response of the magnetic bearing power amplifier connected to its inductive load; a means to emulate the force delivered by the magnetic bearing to the rotor; a means to emulate dynamic response of the rotor to force inputs from the magnetic bearing, residual unbalance, rotor weight, fluid-structure interaction, motor unbalanced magnetic pull; a means to vary to speed of the rotor to emulate operation under different conditions; a means to emulate rotor angular position and velocity transducer such as quadrature encoder or sine/cos resolver using a combination of analog and/or digital signal processing in electronic hardware and software signal processing; a means to vary parameters used to calculate any of the above effects; a means to inject fault conditions to the system;

7. The system of claim 6 and claim 2, wherein: continuous-time dynamic mathematical models are defined for the system electro-mechanical responses; the size or order of the continuous-time dynamic models are reduced to the minimum necessary for an accurate representation of the electro-mechanical response; reduced-order continuous-time dynamic models are discretized for implementation on a sampled discrete digital control system; discrete time models are transformed to realize structures optimal for fast execution on a fixed or floating point digital signal processor;

8. The system of claim 6 defining the magnetic bearing-power amplifier model, further comprising: in the case of analog power amplifiers, the model is implemented in a multitude of 1^{st}, 2^{nd} or 3^{rd} order active low pass filters to offload work from the real-time processor, in the case of digital power amplifiers, the model uses counter/timers (either standalone circuits or part of the real-time computation) to first extract the duty cycle as a voltage command and then implement model with a multitude of 1^{st}, 2^{nd} or 3^{rd} order active low pass filters to offload work from the real-time processor.
